(19) United States
(12) Patent Application Publication
(10) Pub. No.: US 2019/0213487 A1
(43) Pub. Date: Jul. 11, 2019

(54) DYNAMICALLY GENERATING AN ADAPTED RECIPE BASED ON A DETERMINED CHARACTERISTIC OF A USER

(71) Applicant: International Business Machines Corporation, Armonk, NY (US)

(72) Inventors: Michael Karl Gschwind, Chappaqua, NY (US); Anup Kalia, Elmsford, NY (US); Valentina Salapura, Chappaqua, NY (US); Maja Vukovic, New York, NY (US)

(21) Appl. No.: 15/867,252

(22) Filed: Jan. 10, 2018

(51) Int. Cl. G06N 5/04; G06N 3/08; G06N 3/063; G06N 3/04

(52) U.S. Cl. CPC G06N 5/04; G06N 3/0427; G06N 3/0635; G06N 3/08

(57) ABSTRACT

A method includes receiving, by a controller, a request for a recipe from a user. The method also includes determining, by the controller, at least one characteristic of the user. The method also includes retrieving, by the controller, the recipe from a stored collection of recipes. The method also includes dynamically adapting the recipe based on the at least one characteristic of the user. The recipe is adapted based on a comparison of possible adaptations using a subjective logic model. The method also includes generating output recommendation data that communicates the dynamically adapted recipe to the user.

### TECHNICAL FIELD

The present invention relates in general to dynamically generating an adapted recipe based on one or more determined characteristics of a user. More specifically, the present invention relates to using a computer-implemented subjective logic model to dynamically adapt ingredients, ingredient quantities, food presentation, texture, and/or preparation techniques of a recipe based on one or more determined characteristics of the user.

### SUMMARY

A method according to one or more embodiments of the invention includes receiving, by a controller, a request for a recipe from a user. The method also includes determining, by the controller, at least one characteristic of the user. The method also includes retrieving, by the controller, the recipe from a stored collection of recipes. The method also includes dynamically adapting the recipe based on the at least one characteristic of the user. The recipe is adapted based on a comparison of possible adaptations using a subjective logic model. The method also includes generating output recommendation data that communicates the dynamically adapted recipe to the user.

A computer system according to one or more embodiments of the invention includes a memory and a processor system communicatively coupled to the memory. The processor system is configured to perform a method including receiving a request for a recipe from a user. The method also includes determining at least one characteristic of the user. The method also includes retrieving the recipe from a stored collection of recipes. The method also includes dynamically adapting the recipe based on the at least one characteristic of the user. The recipe is adapted based on a comparison of possible adaptations using a subjective logic model. The method also includes generating output recommendation data that communicates the dynamically adapted recipe to the user.

A computer program product according to one or more embodiments of the invention includes a computer-readable storage medium having program instructions embodied therewith. The program instructions are readable by a processor system to cause the processor system to perform a method including receiving a request for a recipe from a user. The method also includes determining at least one characteristic of the user. The method also includes retrieving the recipe from a stored collection of recipes. The method also includes dynamically adapting the recipe based on the at least one characteristic of the user. The recipe is adapted based on a comparison of possible adaptations using a subjective logic model. The method also includes generating output recommendation data that communicates the dynamically adapted recipe to the user.

### BRIEF DESCRIPTION OF THE DRAWINGS

The subject matter of one or more embodiments of the invention is particularly pointed out and distinctly defined in the claims at the conclusion of the specification. The foregoing and other features and advantages are apparent from the following detailed description taken in conjunction with the accompanying drawings in which:

FIG. 1 illustrates a flow diagram for adapting and recommending recipes in accordance with one or more embodiments of the invention;

FIG. 2 depicts a flowchart of a method in accordance with one or more embodiments of the invention;

FIG. 3 depicts a high-level block diagram of a computer system, which can be used to implement one or more embodiments of the invention; and

FIG. 4 depicts a computer program product in accordance with one or more embodiments of the invention.

### DETAILED DESCRIPTION

In accordance with one or more embodiments of the invention, methods and computer program products for adapting a recipe based on one or more characteristics of a user are provided. Various embodiments of the invention are described herein with reference to the related drawings. Alternative embodiments of the invention can be devised without departing from the scope of this invention. References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments of the invention whether or not explicitly described.

Additionally, although this disclosure includes a detailed description of a computing device configuration, implementation of the teachings recited herein are not limited to a particular type or configuration of computing device(s). Rather, embodiments of the present disclosure are capable of being implemented in conjunction with any other type or configuration of wireless or non-wireless computing devices and/or computing environments, now known or later developed.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

For the sake of brevity, conventional techniques related to computer processing systems and computing models may or may not be described in detail herein. Moreover, it is understood that the various tasks and process steps described herein can be incorporated into a more comprehensive procedure, process or system having additional steps or functionality not described in detail herein.

A recipe is a set of instructions that describes how to prepare a specific food. A specific article of food can be referred to as a dish. Certain recipes can be associated with certain geographical areas, and these recipes can use ingredients that are readily available at locations different from the geographical areas to which the recipes are associated with. Certain recipes can also reference different preparation techniques that are typically used within their associated geographical areas.

When a user prepares food by referring to a recipe, the user can encounter difficulties when preparing the food because the recipe can include one or more ingredients that are not readily available to the user at the user's current location. For example, if the user is preparing the food within another person's kitchen/home, preparing the food in a different country/city than the country/city that the recipe is associated with, and/or preparing the food at a location with limited resources, the user can lack one or more ingredients and/or one or more necessary cooking utensils. Different characteristics of the user and/or the user's current circumstances can make it difficult for the user to follow the recipe.

In accordance with the conventional approaches, the user can try to randomly improvise a recipe in order to try to overcome difficulties when preparing the recipe. For example, if an ingredient listed in the recipe is not readily available to the user, then the user can try to experiment with different substitute ingredients to complete the recipe. However, the improvisation of the user can be arbitrary and can yield unpredictable results. Further, the conventional approaches generally do not learn from the user's improvisation and thus the conventional approaches cannot provide learned proposals for improvement.

In view of the above shortcomings of the conventional approaches, one more embodiments of the invention can use a computer-implemented subjective logic model to dynamically adapt recipes in accordance to a characteristic of the user. Determined characteristics of the user can relate to a health state, a current context, a cognitive state, and/or a social state, for example. Proposed adaptations to the recipe can include changing one or more ingredients, a quantity of an ingredient, changing one or more food preparation steps, changing an intended texture, changing an intended presentation, and/or recommending a new hybrid recipe that combines one or more recipes.

Each proposed ingredient, proposed food preparation step, proposed texture, proposed presentation, and proposed combination of recipes can be expressed as an opinion of the subjective logic model. Each opinion of the subjective logic model can be considered to be a proposition which can be true, false, or unknown. Therefore, within the subjective logic model, each proposed option of the recipe can be represented as a proposition to include, to not include, or to be unsure of whether or not to include the option within the recipe. The subjective logic model can quantitatively evaluate a plurality of opinions, and the model can choose which of the opinions should be used, and thus the subjective logic model can quantitatively evaluate whether to incorporate each ingredient, each proposed food preparation step, each proposed texture, each proposed presentation, and/or each recommended combination.

As described in more detail below, each opinion (to use a proposed ingredient, to perform a proposed food preparation step, etc.) can be expressed as a tuple of values which reflect whether the opinion is true, false, or unknown. Each tuple can be implemented as a computer-implemented datatype of values which reflect whether the opinion is true, false, or unknown. These values can be based on data regarding historical use of ingredients, food preparation steps, etc. by different users of the present system. In one example, data regarding the historical use of the ingredients, food preparation steps, etc. can be inputted into a machine learning system to derive the values of the tuples for each opinion. Therefore, one or more embodiments can dynamically derive/update values of tuples for each opinion based on historical data regarding the use of ingredients, food preparation steps, etc. by different users of the present system.

In contrast to the conventional approaches, by using a subjective logic model, one or more embodiments of the invention can dynamically derive/update quantifiable opinions regarding whether to use a proposed ingredient, whether to perform a proposed food preparation step, etc. These quantifiable opinions can be based on historical data that has been inputted into a machine learning system of one or more embodiments of the present invention. Further, one or more embodiments of the present invention can provide a measureable/quantitative representation of a recipe where possible modifications to the recipe are proposed with varying degrees of confidence. In contrast to conventional approaches of arbitrarily adapting recipes to suit the user, one or more embodiments of the present invention can use the subjective logic model to determine a suggested adapted recipe that is quantifiably the best proposed adaptation.

Each opinion of the subjective logic model can be represented as wₓ, where x represents the proposed ingredient, proposed food preparation step, proposed texture, etc. for which the opinion pertains to. If the opinion pertaining to x is a binomial opinion, then the opinion can be represented as a tuple wₓ=(bₓ, dₓ, uₓ), where bₓ is a numerical representation of a belief that the binomial opinion regarding x is true, dₓ is a numerical representation of a belief that the binomial opinion regarding x is false, and u is a numerical representation that the binomial opinion regarding x is uncertain as being true or false. With one or more embodiments of the invention, bₓ+dₓ+uₓ=1.

In order to represent an opinion regarding a proposed ingredient in terms of (bₓ, dₓ, uₓ), one or more embodiments of the invention observe the historical data with respect to the ingredient. Specifically, from the historical data, one or more embodiments can determine how many instances that the proposed ingredient has been present, or has not been present, in a recipe. The determined instances can be represented as “r” and “s,” where “r” represents the number of times that the proposed ingredient has been present in a recipe, and where “s” represents the number of times that the proposed ingredient has not been present in a recipe. To determine “r” and “s,” one or more embodiments of the present invention use natural-language processing techniques to mine external data from sources such as wiki pages, news articles, culinary books, courses, and/or journals, for example. Once “r” and “s” are determined, one or more embodiments of the invention can compute bₓ, dₓ, uₓ as follows:

bₓ=((r+W)/(r+s+W)), uₓ=((s+W)/(r+s+W)), and uₓ=((W)/(r+s+W)),

where W is a prior weight for the proposed ingredient.

Suppose there are two opinions w₁ and w₂. If both opinions (w₁=<b₁, d₁, u₁> and w₂=<b₂, d₂, u₂>) are both affirmatively expressed, then the two opinions can be aggregated as:

w_{aggregated}=<(b₁+b₂)/2,(d₁+d₂)/2,1−((b₁+b₂)/2+(d₁+d₂)/2)>

If opinion w₁ is expressed in the affirmative, while opinion w₂ is expressed in the negative, then the two opinions can be aggregated as:

w_{aggregated}=<(b₁+d₂)/2,(d₁+b₂)/2,1−((b₁+d₂)/2+(d₁+b₂)/>

If opinion w₁ is expressed in the negative, while opinion w₂ is expressed in the affirmative, then the two opinions can be aggregated as:

w_{aggregated}=<(d₁+b₂)/2,(b₁+d₂)/2,1−((d₁+b₂)/2+(b₁+d₂)/>

If opinion w₁ is expressed in the negative, while opinion w₂ is also expressed in the negative, then the two opinions can be aggregated as:

w_{aggregated}=<(d₁+d₂)/2,(b₁+b₂)/2,1−((d₁+d₂)/2+(b₁+b₂)/>

As described above, each opinion relating to a recipe can be represented as wₓ, where x represents the proposed ingredient, proposed food preparation step, proposed texture, etc. for which the opinion pertains to. For example, suppose that a user is attempting to prepare a rice pudding recipe. The proposed ingredients for the rice pudding recipe can be represented as follows. The following numerical values can be obtained through survey data, through analysis of correlations of ingredients within recipes, and/or through analysis of correlations of ingredients that are used by different users.

The opinion to include rice can be represented as w_{rice}=<0.7, 0.2, 0.1>
The opinion to include milk can be represented as wₘᵢₗₖ=<0.5, 0.3. 0.2>
The opinion to include butter can be represented as w_{butter}=<0.7, 0.2, 0.2>
The opinion to include sugar can be represented as w_{sugar}=<0.8, 0.1, 0.1>

In order to determine an example aggregate opinion of combining rice, milk, and butter, each opinion can be incorporated one at a time to form the aggregate opinion as follows.

$$\begin{matrix}{w}_{rice} + {w}_{milk} + {w}_{butter} = 〈 ( 0.7 + 0.5 ) \text{/} 2 , ( 0.2 + 0.3 ) \text{/} 2 , \\ 1 - ( ( 0.7 + 0.5 ) \text{/} 2 + ( 0.2 + 0.3 ) \text{/} 2 ) 〉 + {w}_{butter} \\ = 〈 0.6 , 0.25 , 0.15 〉 + {w}_{butter} \\ = 〈 ( 0.6 + 0.7 ) \text{/} 2 , ( 0.25 + 0.2 ) \text{/} 2 , \\ 1 - ( ( 0.6 + 0.7 ) \text{/} 2 + ( 0.25 + 0.2 ) \text{/} 2 ) 〉 \\ = 〈 0.65 , 0.225 , 0.125 〉\end{matrix}$$

However, in this example, further suppose that the user's health profile indicates that the user is a diabetic who cannot consume sugar. As such, the affirmative aggregate opinion of w_{rice}+ₘᵢₗₖ+w_{butter}=<0.65, 0.225, 0.175> is aggregated with a negative opinion of w_{sugar}=<0.8, 0.1, 0.1> as follows:

$$\begin{matrix}〈 0.65 , 0.225 , 0.175 〉 - {w}_{sugar} = 〈 ( 0.65 + 0.1 ) \text{/} 2 , ( 0.225 + 0.8 ) \text{/} 2 , \\ 1 - ( ( 0.65 + 0.1 ) \text{/} 2 + ( 0.225 + 0.8 ) \text{/} 2 ) 〉 \\ = 〈 0.375 , 0.5125 , 0.1125 〉\end{matrix}$$

In view of the above, the aggregate opinion of adding rice, milk, and butter, while excluding sugar, can be expressed as <0.375, 0.5125, 0.1125>. The numerical representation of the affirmative belief of this opinion (bₓ) is 0.375. The numerical representation of belief of this opinion can be compared against other aggregate opinions (which correspond to other combinations of other ingredients, food preparation methods, textures, etc.) to determine which aggregate opinion to use, and thus which corresponding recipe to recommend. A larger numerical representation can correspond to a greater likelihood of recommending the corresponding aggregate opinion/recipe to the user. Therefore, one or more embodiments of the present invention can quantitatively evaluate whether to incorporate each ingredient, each proposed food preparation step, each proposed texture, each proposed presentation, and/or each recommended combination.

With regard to dynamically adapting recipes in accordance to a health state, one or more embodiments of the invention can dynamically adapt recipes based on the health state of the user. In one or more embodiments of the invention, a user can establish an electronic user profile that includes information relating to the user's health, as described in more detail below. The user profile can reflect a blood pressure, cholesterol level, body fat, a metabolic disorder, weight, a height, a nutrient deficiency, an age, and/or an allergy of the user, for example.

For example, one or more embodiments of the invention can adapt a recipe so that the prepared food is healthier for diabetic users, healthier for users with abnormal blood pressure, healthier for users with abnormal cholesterol levels, etc. One or more embodiments of the invention can also adapt a recipe based on particular dietary restrictions that result from the user's health condition. For example, based on the user's health condition, one or more embodiments of the invention can adapt a recipe to limit a level of sugar/salt that is used, to decrease or increase an amount of protein that is used, to decrease or increase an amount of calcium that is used, and/or to increase an amount of vitamins that are present within the prepared food. One or more embodiments of the invention can also adapt recipes in accordance to a health state of a person who consumes food that is prepared by the user. The proposed ingredients (in accordance to the health state) can be inputted into the subjective logic model to quantifiably determine an adapted recipe for the user.

With regard to dynamically adapting recipes in accordance to a current context, one or more embodiments of the invention can adapt recipes based on a current time, a current location of the user, a current temperature, a current set of available ingredients, a current set of available cooking devices, and/or a current social setting/event, etc.

Specifically, if an ingredient of a recipe is not readily available at the current location, one or more embodiments of the invention can determine available possible substitute ingredients (that can be obtained at the current geographical location of the user). With one or more embodiments of the invention, a user can prompt changes to the recipe ingredients, or changes to the ingredients can be automatically initiated if one or more embodiments of the invention has determined that a particular recipe ingredient is not likely to be available at the current location of the user.

In order to adjust the ingredients of a recipe, one or more embodiments of the invention can use a ranking mechanism to rank possible substitute ingredients based on co-ingredients or based on processing steps. Rankings can either be used with traditional machine learning techniques (e.g., by performing clustering of recipe step groups, or subingredient groups, and then ranking substitute ingredients within a cluster), or by using a deep learning substitution mechanism wherein ingredients and/or steps may have been trained to be used.

In one example, suppose that the current location of the user is Italy and that the user would like to prepare a pie that is similar to a blueberry pie. Further, suppose that blueberries are not readily available in Italy and that the user needs to find a substitute ingredient for the blueberries. One or more embodiments of the invention can determine one or more substitute ingredients. For example, one or more embodiments of the invention can analyze a plurality of recipes that are similar to the recipe for blueberry pie in order to determine the types of berries which appear in a similar combination of ingredients as blueberries within blueberry pie. Depending on the type of berries that are determined as a substitute for blueberries, one or more embodiments of the invention can also determine any further adjustments that are necessary to the recipe. In other words, one or more embodiments of the invention can determine a characteristic of the substitute ingredient and can further modify the recipe based on the determined characteristic of the substitute ingredient. The determined characteristic of the substitute ingredient can include a level of sweetness, a level of sour, a level of salt, an amount of moisture, a spiciness level, an amount of a particular nutrient, a texture, a health effect, and/or a color, for example. The proposed modifications (in accordance to the current context) can be inputted into the subjective logic model to quantifiably determine an adapted recipe for the user.

For example, one or more embodiments of the invention can further adapt/calibrate an amount of sugar to use in the recipe in order to account for the different sweetness levels of the different berries. As such, the sweetness level that corresponds to the recipe for blueberry pie can be reproduced with a different type of berry. Further, one or more embodiments of the invention can modify other ingredients such as, for example, flour and/or bread crumbs to absorb any excess liquid that is present in the substitute berry as compared to blueberries.

One or more embodiments of the invention can automatically convert units of measurement (that are referenced within a recipe) to locally-used units of measurement. One or more embodiments of the invention can also update a cooking time and/or a temperature setting of a recipe based on appliances that are currently available to the user. As such, in contrast to a recipe book that presents recipes in a static format, one or more embodiments of the invention can present recipes that are dynamically modified/adjusted based on contextual characteristics of the user.

With further regard to dynamically adapting recipes in accordance to a current context, one or more embodiments of the invention can also adjust recipes in accordance with local expectations of the current location. Specifically, one or more embodiments of the invention can first use a deep-learning based method to extract key attributes of a recipe. For example, one or more embodiments of the invention can extract key attributes of a recipe to determine a type of cuisine that the recipe is intended to produce such as, for example, “Italian cuisine/cooking” or “American cuisine/cooking.” Upon determining the key attributes of the recipe, one or more embodiments of the invention can then modify the attributes of the recipe to match local expectations/tastes. For example, one or more embodiments of the invention can apply an “Italian cuisine/cooking” style to a Polish recipe, in order to make the Polish recipe in accordance with an “Italian” cooking style.

As another example, Chinese cuisine in China can taste very different than Chinese cuisine in the United States, Cuba, Italy, etc. As such, one or more embodiments of the invention can modify a recipe to use cooking styles and ingredients that are pleasing to the palate of a particular location. Therefore, one or more embodiments of the invention can learn key ingredient styles and techniques from recipes, and these learned ingredients and techniques can be adjusted. For example, because French cooking tends to use larger amounts of cream, one or more embodiments of the invention can adjust a Hungarian Goulash recipe to include more cream in order to make the Goulash to more appealing to the French palate.

With further regard to dynamically adapting recipes in accordance to a current context, one or more embodiments of the invention can adapt a recipe in order to account for differences in flavor or differences in texture of ingredients between two different geographical areas. For example, depending on the geographic location, cooking chocolate can be of different sweetness and different texture. As such, the user can have difficulty accounting for the differences and thus the user can have difficulty preparing the food that is intended by the recipe.

For example, suppose that a user wants to bake a cake with chocolate glazing but the German cooking chocolate that the users wishes to use is not available. One or more embodiments of the invention can identify the differences in glazing recipes between two different geographic areas and can provide a recommendation on how to properly glaze cakes in each of the two geographic areas (United States and Germany). One or more embodiments of the invention can then adapt a recipe in order to allow the user to properly perform glazing with the locally-available chocolate.

With regard to dynamically adapting recipes in accordance to a cognitive state, one or more embodiments of the invention can determine/infer a cognitive state of the user and can adjust a recipe accordingly. In one example, one or more embodiments of the invention can determine that the user has a tired cognitive state if the current time is late in the day and the recipe is being prepared later as compared to the usual consumption pattern of the user. In another example, one or more embodiments of the invention can determine the user's state of mind based on direct input that is received from the user or based on input that is received from external sources.

One or more embodiments of the invention can adapt a recipe to have a more exciting taste or presentation if the user is determined to have a bored state of mind. One or more embodiments of the invention can also adjust a recipe to be prepared more quickly if the user is determined to have a tired/distracted state of mind.

Further, suppose that one or more embodiments of the invention determines that a user has a depressed and/or stressed cognitive state. One or more embodiments of the invention can receive the user's cognitive state as an input and can recommend ingredients that are supposed to alleviate the user's cognitive state. If the user is determined to be depressed/stressed, one or more embodiments of the invention can recommend stress-alleviating ingredients such as avocados, berries, cashews, chocolate, garlic, oranges, oysters, etc. With the list of recommended ingredients, one or more embodiments of the invention can use one or more of the recommended ingredients. For example, one or more embodiments of the invention can recommend a recipe for a freshly-made dessert that includes oranges, chocolate, cashews, and a hint of berries. In another use case, suppose that the user is suffering from the flu. In this case, one or more embodiments of the invention can recommend appropriate recipes that might be a remedy for the flu, such as a recipe for hot toddy, a recipe for chicken soup, etc. The proposed modifications (in accordance to the cognitive state) can be inputted into the subjective logic model to quantifiably determine an adapted recipe for the user.

With regard to dynamically adapting recipes in accordance to a social state, one or more embodiments of the invention can adjust a recipe based on a user's social connections. For example, one or more embodiments of the invention can recommend modifications to recipes for a user based on the user's relationships with people of other countries. One or more embodiments of the invention can adapt a recipe to use ingredients or cooking methods that are associated with these other countries. For example, one or more embodiments of the invention can adapt recipes for a user based on the ingredients and palates of the user's friends' home countries.

Suppose that a user has moved from the United States to India. Further, suppose that the user enjoys eating hamburgers and pepperoni pizza. Because hamburgers and pepperoni pizzas are generally difficult to obtain in India (due to restrictions on meat), the user can ask an Indian friend for references for new recipes to try. In this example, the Indian friend suggests some curry recipes such as, for example, chicken tikka masala, chicken tandoor, and lamb sheekh kababs. The user can input the user's preference for pizzas and hamburgers into a system of one or more embodiments of the invention, and the user can also input the recommended curry recipes. One or more embodiments of the invention can also determine the user's preference for pizza/hamburgers based on historical information.

One or more embodiments of the invention can then analyze the inputs and can generate a new hybrid recipe such as chicken tikka burgers, tandoor or sheekh kababs pizza, and/or any other type of recipe that is based on the user inputs. One or more embodiments of the invention can also analyze a determined friendship strength between the user and the Indian friends to determine whether or not to adapt recipes in accordance to Indian tastes. If the user has a strong association with an Indian friend, then the likelihood of substituting unavailable ingredients with Indian ingredients can be increased. The proposed modifications (in accordance to the social state) can be inputted into the subjective logic model to quantifiably determine an adapted recipe for the user.

As described above, adaptations to the recipe can include changing an intended texture, changing an intended presentation, and/or recommending a new hybrid recipe that combines one or more recipes, for example. Example textures can include a texture with a burnt look, a texture that appears loosely assembled, a texture that is crispy, a texture that is soft, a texture that is fried, a texture that is flakey, a texture that is half-boiled, etc. An example presentation can include a visual presentation and/or a garnish. For example, an example presentation for porridge can be porridge that is served with a side of rhubarb jelly in the shape of a smiley face. Example hybrid dishes can include cronuts, spaghetti donuts, chicken tikka burgers, Mexican naan, etc.

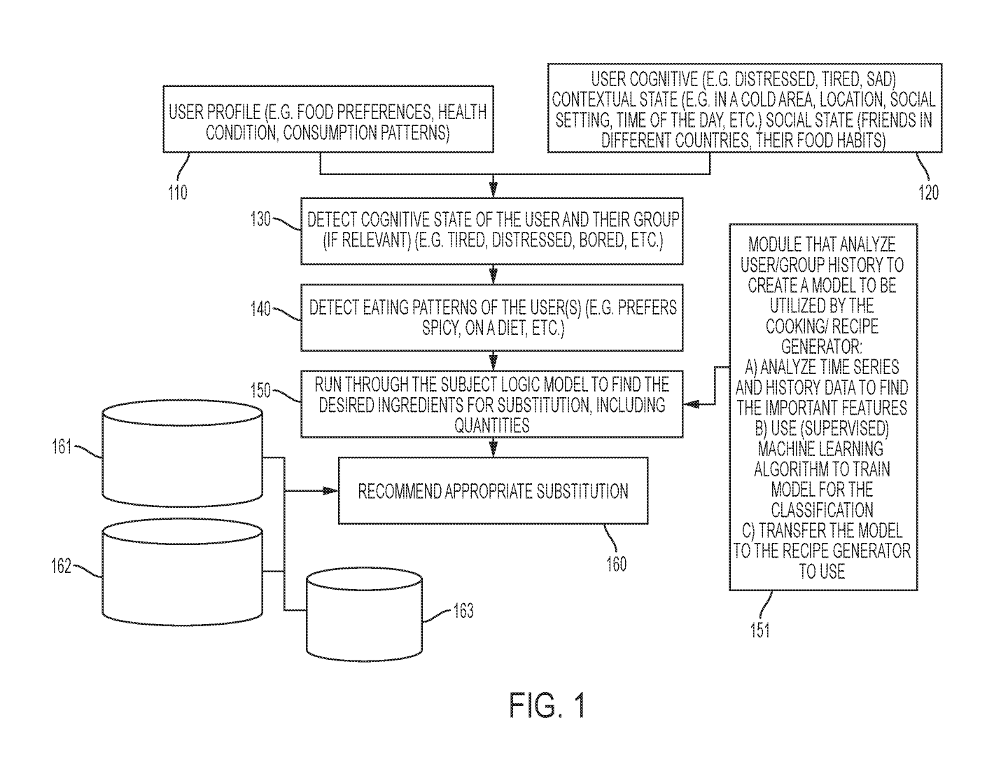

FIG. 1 illustrates a flow diagram for adapting and recommending recipes in accordance with one or more embodiments of the invention. As described above, with one or more embodiments of the invention, a user profile 110 can be configured to reflect the food preferences, health conditions, and consumption patterns of the user, for example. The user profile 110 can describe one or more dietary preferences of the user. For example, the user profile 110 can indicate a preferred level of spice/sweetness, one or more preferred ingredients, and/or one or more people that the user typically cooks for (as well as the culinary requirements, needs, and preferences of these other people).

User cognitive information 120 can be configured to reflect the user's cognitive state, contextual state, and/or social state. One or more embodiments of the invention can also determine such state information without direct input from the user. Upon receiving the user profile 110 and cognitive information 120 as inputs, at 130, one or more embodiments of the invention can determine a cognitive state of the user and/or a person that the user is cooking for, if applicable. At 140, one or more embodiments of the invention can determine eating patterns of the user. For example, one or more embodiments of the invention can determine the eating patterns based on the user profile. At 150, one or more embodiments of the invention can use a model (such as, for example, the above-described subjective logic model) to determine if any ingredients should be substituted, if any quantities of ingredients should be modified, which cooking methods to use, which textures to use, which presentation methods to use, etc. In order to perform step 160, one or more embodiments can use module 151. Processer/module 151 can analyze a user or group history to determine a model to use to adapt and recommend recipes. One or more embodiments of the invention analyze a time series and history data to find the important features that are to be considered by the model. One or more embodiments of the invention can use a machine-learning algorithm to train the model. One or more embodiments of the invention then use the model to adapt and recommend recipes. At 160, one or more embodiments of the invention can recommend appropriate substitutions. The recommended recipe can be compared against recipes that are stored in a digital repository 161 and be compared against intelligence that is provided by an intelligent recipe system 162. One or more embodiments of the invention can also compare the ingredients of the recommended recipe against a repository of information regarding similar ingredients and other applicable ingredients 163. The recommended recipe can then be modified if the comparisons determine that a more suitable ingredient or preparation method is needed.

Based on the dietary requirements that are reflected in the user's profile, one or more embodiments of the invention can modify and/or remove ingredients of the recipe. For example, if a user is diabetic, then one or more embodiments of the invention can determine a level of sugar that a diabetic person needs from historical data, and one or more embodiments of the invention can prepare a dessert according to the determined level of sugar. If a user has high-blood pressure, then one or more embodiments of the invention can moderate the amount of added salt when preparing a curry. Similarly, one or more embodiments of the invention can enhance a level of calcium within a recipe if the user has osteoporosis.

With one or more embodiments of the invention, the user can search for a recipe. When the user initiates a search for the recipe, one or more embodiments of the invention initiates a search for the recipe within a locally-stored collection and/or via an online search. Upon completion of the search, the user is presented with a list of available recipes, and the user can choose one of the available recipes. One or more embodiments of the invention can then dynamically update at least the chosen recipe, where the updated recipe can reflect the available contextual information/characteristics relating to the user.

One or more embodiments of the invention can also customize a recipe and can organize tasks so that they can be performed in parallel with one another. By organizing tasks so that they can be performed in parallel, one or more embodiments of the invention can allow a recipe to be prepared more efficiently, and thus one or more embodiments of the invention can allow users to more easily cater large amounts of food for events/parties.

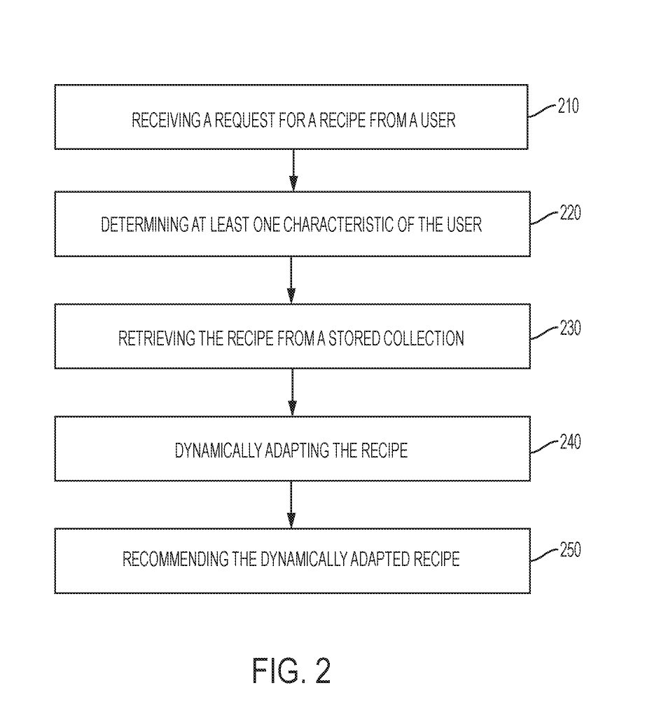

FIG. 2 depicts a flowchart of a method in accordance with one or more embodiments of the invention. The method of FIG. 2 can be performed by a controller of a system that is configured to adapt and recommend recipes. The method of FIG. 2 can also be performed by a processor of an application server that adapts and recommends recipes. The application server can be a special-purpose application server that performs the specific functionality illustrated by FIG. 2. The method of FIG. 2 can also be performed by a machine-learning system or in conjunction with a machine-learning system. As described above, data regarding historical use of ingredients, food preparation steps, etc. can be inputted into a machine-learning system to derive values of tuples for each of the above-described opinions. The machine-learning system can be based on, for example, one or more artificial neural networks (ANNs), which can use electronic components that mimic the processing architecture of the human brain. Artificial neural networks are often embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning.

The method includes, at block 210, receiving, by a controller, a request for a recipe from a user. The method also includes, at block 220, determining at least one characteristic of the user. The method also includes, at block 230, retrieving the recipe from a stored collection of recipes. The method also includes, at block 240, dynamically adapting the recipe based on the at least one characteristic of the user. The recipe is adapted based on a comparison of possible adaptations using a subjective logic model. The method also includes, at block 250, generating output recommendation data that communicates the dynamically adapted recipe to the user.

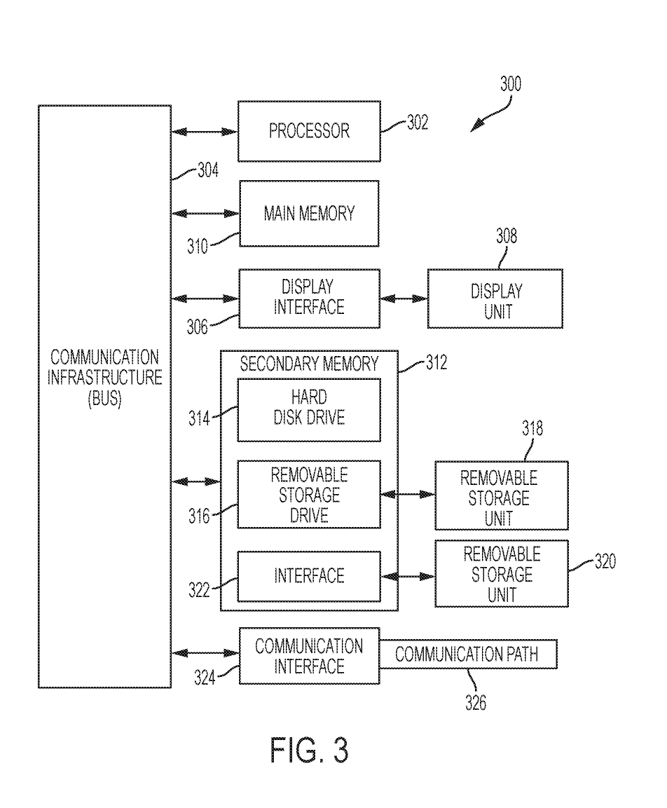

FIG. 3 depicts a high-level block diagram of a computer system 300, which can be used to implement one or more embodiments of the invention. Computer system 300 can correspond to, at least, a recipe application server, for example. Computer system 300 can be used to implement hardware components of systems capable of performing methods described herein. Although one exemplary computer system 300 is shown, computer system 300 includes a communication path 326, which connects computer system 300 to additional systems (not depicted) and can include one or more wide area networks (WANs) and/or local area networks (LANs) such as the Internet, intranet(s), and/or wireless communication network(s). Computer system 300 and additional system are in communication via communication path 326, e.g., to communicate data between them.

Computer system 300 includes one or more processors, such as processor 302. Processor 302 is connected to a communication infrastructure 304 (e.g., a communications bus, cross-over bar, or network). Computer system 300 can include a display interface 306 that forwards graphics, textual content, and other data from communication infrastructure 304 (or from a frame buffer not shown) for display on a display unit 308. Computer system 300 also includes a main memory 310, preferably random access memory (RAM), and can also include a secondary memory 312. Secondary memory 312 can include, for example, a hard disk drive 314 and/or a removable storage drive 316, representing, for example, a floppy disk drive, a magnetic tape drive, or an optical disc drive. Hard disk drive 314 can be in the form of a solid state drive (SSD), a traditional magnetic disk drive, or a hybrid of the two. There also can be more than one hard disk drive 314 contained within secondary memory 312. Removable storage drive 316 reads from and/or writes to a removable storage unit 318 in a manner well known to those having ordinary skill in the art. Removable storage unit 318 represents, for example, a floppy disk, a compact disc, a magnetic tape, or an optical disc, etc. which is read by and written to by removable storage drive 316. As will be appreciated, removable storage unit 318 includes a computer-readable medium having stored therein computer software and/or data.

In alternative embodiments of the invention, secondary memory 312 can include other similar means for allowing computer programs or other instructions to be loaded into the computer system. Such means can include, for example, a removable storage unit 320 and an interface 322. Examples of such means can include a program package and package interface (such as that found in video game devices), a removable memory chip (such as an EPROM, secure digital card (SD card), compact flash card (CF card), universal serial bus (USB) memory, or PROM) and associated socket, and other removable storage units 320 and interfaces 322 which allow software and data to be transferred from the removable storage unit 320 to computer system 300.

Computer system 300 can also include a communications interface 324. Communications interface 324 allows software and data to be transferred between the computer system and external devices. Examples of communications interface 324 can include a modem, a network interface (such as an Ethernet card), a communications port, or a PC card slot and card, a universal serial bus port (USB), and the like. Software and data transferred via communications interface 324 are in the form of signals that can be, for example, electronic, electromagnetic, optical, or other signals capable of being received by communications interface 324. These signals are provided to communications interface 324 via a communication path (i.e., channel) 326. Communication path 326 carries signals and can be implemented using wire or cable, fiber optics, a phone line, a cellular phone link, an RF link, and/or other communications channels.

In the present description, the terms “computer program medium,” “computer usable medium,” and “computer-readable medium” are used to refer to media such as main memory 310 and secondary memory 312, removable storage drive 316, and a hard disk installed in hard disk drive 314. Computer programs (also called computer control logic) are stored in main memory 310 and/or secondary memory 312. Computer programs also can be received via communications interface 324. Such computer programs, when run, enable the computer system to perform the features discussed herein. In particular, the computer programs, when run, enable processor 302 to perform the features of the computer system. Accordingly, such computer programs represent controllers of the computer system. Thus it can be seen from the foregoing detailed description that one or more embodiments of the invention provide technical benefits and advantages.

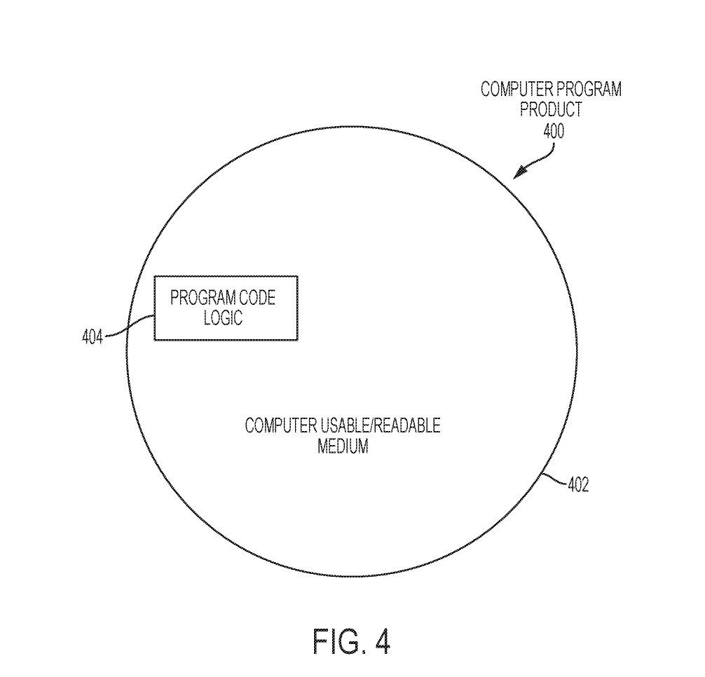

FIG. 4 depicts a computer program product 400, in accordance with an embodiment. Computer program product 400 includes a computer-readable storage medium 402 and program instructions 404.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving, by a controller, a request for a recipe from a user;
determining, by the controller, at least one characteristic of the user;
retrieving, by the controller, the recipe from a stored collection of recipes;
dynamically adapting the recipe based on the at least one characteristic of the user, wherein the recipe is adapted based on a comparison of possible adaptations using a subjective logic model; and
generating output recommendation data that communicates the dynamically adapted recipe to the user.

2. The computer-implemented method of claim 1, wherein determining at least one characteristic of the user comprises determining at least one of a health state, a current context, a cognitive state, and a social state of the user.

3. The computer-implemented method of claim 1, wherein dynamically adapting the recipe comprises adapting an item from a group consisting of an ingredient, a quantity of an ingredient, a food preparation step, an intended texture, a presentation, and a combination with another recipe.

4. The computer-implemented method of claim 1, wherein the at least one characteristic of the user is determined based on a user profile of the user.

5. The computer-implemented method of claim 1, wherein dynamically adapting the recipe comprises substituting an ingredient of the recipe with a different ingredient that is more available at the location of the user.

6. The computer-implemented method of claim 1, wherein dynamically adapting the recipe comprises adapting the recipe based on a home country of a friend of the user.

7. The computer-implemented method of claim 1, wherein dynamically adapting the recipe comprises adapting the recipe based at least in part on a country in which the user is located.

8. A computer system comprising:
a memory; and
a processor system communicatively coupled to the memory;
the processor system configured to perform a method comprising:
receiving a request for a recipe from a user;
determining at least one characteristic of the user;
retrieving the recipe from a stored collection of recipes;
dynamically adapting the recipe based on the at least one characteristic of the user, wherein the recipe is adapted based on a comparison of possible adaptations using a subjective logic model; and
generating output recommendation data that communicates the dynamically adapted recipe to the user.

9. The computer system of claim 8, wherein determining at least one characteristic of the user comprises determining at least one of a health state, a current context, a cognitive state, and a social state of the user.

10. The computer system of claim 8, wherein dynamically adapting the recipe comprises adapting an item from a group consisting of an ingredient, a quantity of an ingredient, a food preparation step, an intended texture, a presentation, and a combination with another recipe.

11. The computer system of claim 8, wherein the at least one characteristic of the user is determined based on a user profile of the user.

12. The computer system of claim 8, wherein dynamically adapting the recipe comprises substituting an ingredient of the recipe with a different ingredient that is more available at the location of the user.

13. The computer system of claim 8, wherein dynamically adapting the recipe comprises adapting the recipe based on a home country of a friend of the user.

14. The computer system of claim 8, wherein dynamically adapting the recipe comprises adapting the recipe based at least in part on a country in which the user is located.

15. A computer program product comprising a computer-readable storage medium having program instructions embodied therewith, the program instructions readable by a processor system to cause the processor system to:
receive a request for a recipe from a user;
determine at least one characteristic of the user;
retrieve the recipe from a stored collection of recipes;
dynamically adapt the recipe based on the at least one characteristic of the user, wherein the recipe is adapted based on a comparison of possible adaptations using a subjective logic model; and
generate output recommendation data that communicates the dynamically adapted recipe to the user.

16. The computer program product of claim 15, wherein determining at least one characteristic of the user comprises determining at least one of a health state, a current context, a cognitive state, and a social state of the user.

17. The computer program product of claim 15, wherein dynamically adapting the recipe comprises adapting an item from a group consisting of an ingredient, a quantity of an ingredient, a food preparation step, an intended texture, a presentation, and a combination with another recipe.

18. The computer program product of claim 15, wherein the at least one characteristic of the user is determined based on a user profile of the user.

19. The computer program product of claim 15, wherein dynamically adapting the recipe comprises substituting an ingredient of the recipe with a different ingredient that is more available at the location of the user.

20. The computer program product of claim 15, wherein dynamically adapting the recipe comprises adapting the recipe based on a home country of a friend of the user.
